(19) United States
(12) Patent Application Publication
(10) Pub. No.: US 2020/0385996 A1
(43) Pub. Date: Dec. 10, 2020

(54) CASSETTE FRAMING SYSTEM

(71) Applicant: KPA Studios Inc, Richmond Hill, NY (US)

(72) Inventors: Jihan T. Kim, Plainview, NY (US); Daniel Chung, Richmond Hill, NY (US)

(73) Assignee: KPA Studios Inc, Richmond Hill, NY (US)

(21) Appl. No.: 16/906,671

(22) Filed: Jun. 19, 2020

Related U.S. Application Data
(63) Continuation of application No. 15/935,207, filed on Mar. 26, 2018, now abandoned.
(60) Provisional application No. 62/477,315, filed on Mar. 27, 2017.

(51) Int. Cl. E04F 13/08; E06B 1/36; E04B 2/96

(52) U.S. Cl. CPC E04F 13/083; E06B 3/5427; E04B 2/96; E06B 1/366

(57) ABSTRACT

The present invention relates to a cassette framing system consisting of at least one hinge assembly and cassette, with a cassette frame, which allows for loading the top of a cassette frame onto a structural mullion located within a cassette framing system. The hinge assembly permits the installer to stabilize and align the cassette and cassette frame during the installation of the cassette frame onto the cassette framing system. The cassette framing system permits the use of a plurality of different types of infill materials within the cassette. The use of a hinge assembly permits ease of field installation while employing narrow joint profiles which have aesthetic benefits.

### FIELD OF THE INVENTION

The present invention relates to cassette framing systems, and more particularly to cassette framing systems using hinge assembly units. These hinge assembly units employ narrow joint profiles which provide aesthetics benefits. They also enable the ease of on the field installations. A cassette framing system includes at least one cassette comprising a frame and infill material, and at least one hinge assembly unit, which allows for loading the top of a cassette frame onto a structural mullion located within the cassette framing system.

### DESCRIPTION OF THE PRIOR ART

The present invention refers to a cassette framing system consisting of one or more cassettes framed within a cassette framing system. Cassette framing systems are well known within the art. Such cassette framing systems have however, employed installation techniques different from those employed by the present invention. Such prior art systems do not provide for ease of use in the field and/or provide for bulkier joint profiles.

The prior art includes cassette framing systems using project-in fastening systems for loading a cassette within a cassette framing system. The project-in fastening systems required that a cassette be held in place in its target location by one or more installers, while the cassettes were fastened in the field. See FIG. 14. While project-in fastener systems involve smaller joint profiles, additional man hours and skilled labor are required to stabilize and hold a cassette in place while the cassette is fastened to the cassette frame. As the cassettes can have significant weight in the hundreds or thousands of pounds, holding the cassettes in place posed physical dangers to the installers, if the cassettes were to slip out of or within the cassette framing system. The cassettes may also be large in size, rendering the handling of the cassettes unwieldy and cumbersome.

Other prior art includes cassette framing systems using hook-on fastening systems for loading a cassette within a cassette framing system. Such hook-on systems provide some convenience and ease in on the field installations but required the use of larger joint profiles. See FIG. 15. The hook on systems have exterior horizontal dimensions which must be sufficiently sized to permit a cassette with an attached hook to be raised, angled, and mounted onto a structural mullion, within those horizontal dimensions. These hook on systems therefore required the use of additional space around the cassette frame, which resulted in larger joint profiles. These larger joint profiles detract from the aesthetics of the cassette framing systems, as they created a bulkier appearance.

### SUMMARY OF THE INVENTION

It is an object of the present invention to create a cassette framing system of the aforementioned kind that will remedy the drawbacks of the known solutions. The cassette framing system according to the present invention substantially departs from conventional concepts and designs in the prior art. In so doing, it provides an apparatus which neither uses prior art devices such as project-in fasteners or hook-on fasteners. An aspect of the present invention is to provide a cassette framing system which provides for convenient on the field installation of cassettes within the framing system, while providing an aesthetically favorable joint profile.

### BRIEF DESCRIPTION OF DRAWINGS

The present invention is described in greater detail below on the basis of the embodiments and of the drawings:

FIG. 1 shows a schematic representation of a layout for cassettes to be installed within a cassette framing system, which includes a hinge installed cassette façade.

FIG. 2 shows a schematic representation of vertical mullions attached to anchor points within a cassette framing system.

FIG. 3 shows a schematic representation of horizontal mullions attached to vertical mullions and to anchor points within a cassette framing system.

FIG. 4 shows a schematic representation of cassettes attached to structural mullions within a cassette framing system.

FIG. 5 defines a partial view of a schematic representation of cassettes attached to structural mullions within a cassette framing system.

FIG. 6 shows a schematic representation of a single cassette mounted within a cassette framing system and within the partial schematic representation defined in FIG. 5.

FIG. 7 shows a schematic representation of a partial view of a cassette framing system, with a cassette being mounted onto the cassette framing system and within the partial schematic representation defined in FIG. 5.

FIG. 8 shows a schematic representation of a partial view of a cassette framing system, with a cassette mounted onto the cassette framing system and within the partial schematic representation defined in FIG. 5.

FIG. 9 shows a schematic representation of a partial side view of a hinge assembly within a cassette framing system.

FIG. 10 further shows a schematic representation of a partial side view of a hinge assembly, with a cassette being mounted within a cassette framing system.

FIG. 11 further shows a schematic representation of a partial side view of a hinge assembly, with a cassette in mounted position within a cassette framing system.

FIG. 12 shows a schematic representation of a partial side view of a cassette within a cassette framing system, with a second cassette assembly being mounted into the cassette framing system.

FIG. 13 further shows a schematic representation of a partial side view of a cassette within a cassette framing system, with a second cassette assembly mounted and position directly above the first cassette.

FIG. 14 shows a schematic representation of a prior art cassette framing system employing project-in fasteners.

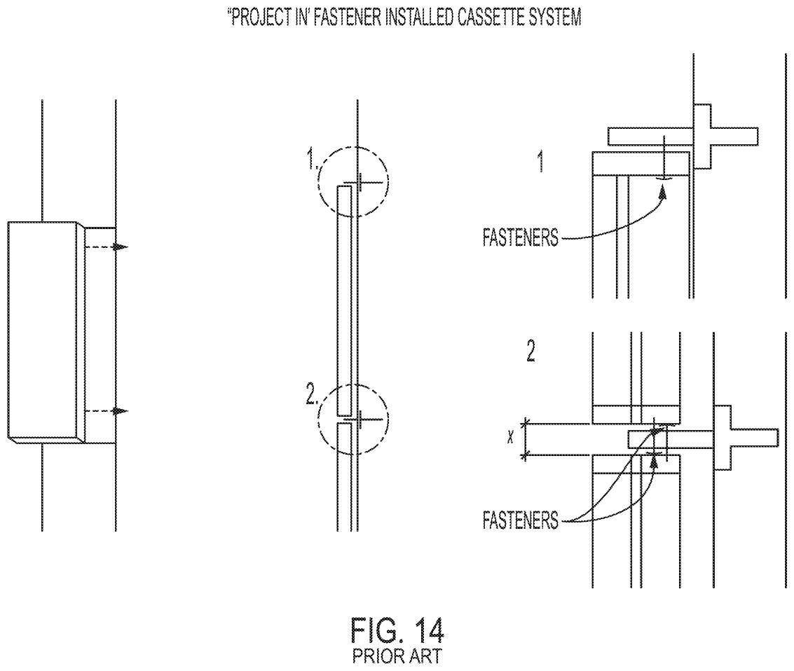

FIG. 15 shows a schematic representation of a prior art cassette framing system employing hook-on fasteners.

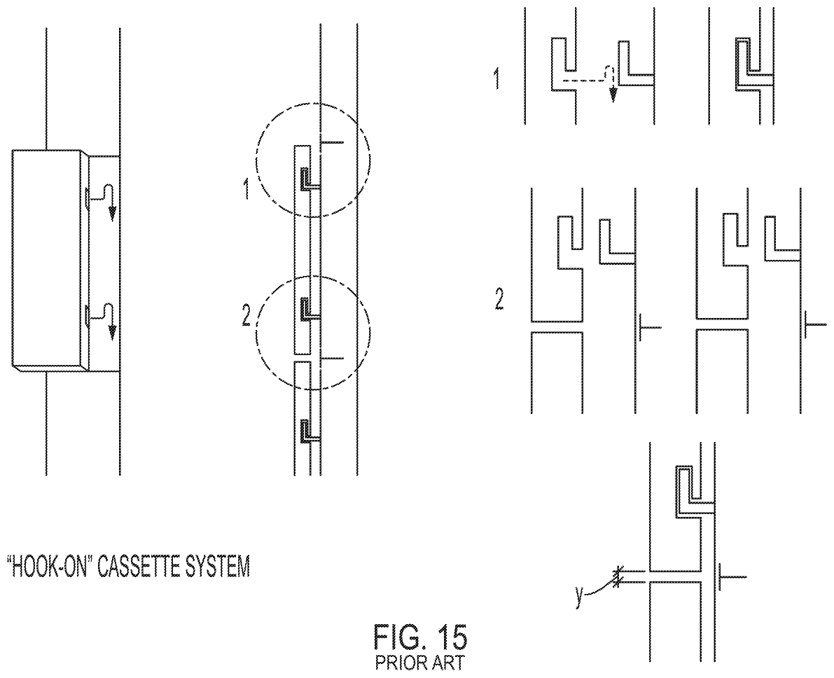

### DESCRIPTION OF THE PREFERRED EMBODIMENT

In view of the foregoing disadvantage inherent in the prior art, the present invention provides the convenience of on the field installation, while employing a narrow joint profile in the form of a hinge.

In an embodiment of the present invention, the cassette framing system is designed such that the top of the cassette may be aligned onto an anchor, which results in the stabilization and alignment of the cassette while the cassette is lowered or moved into place.

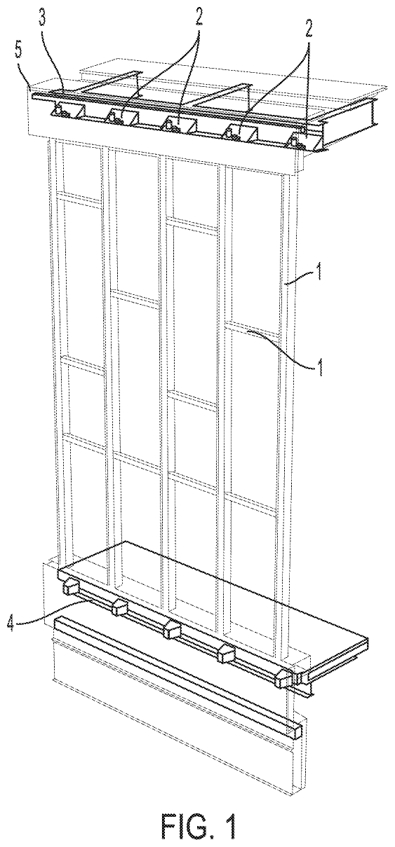

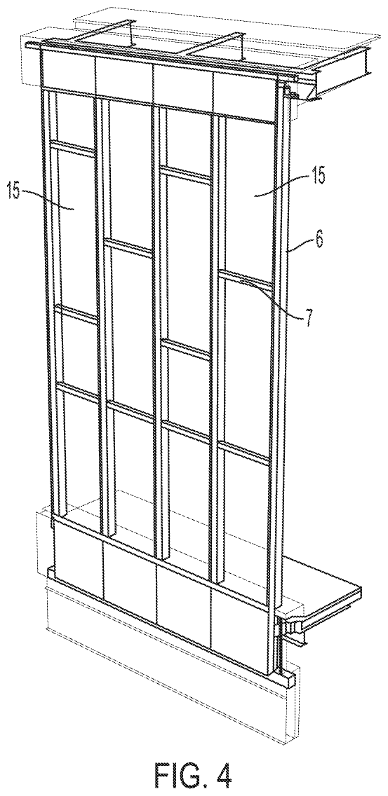

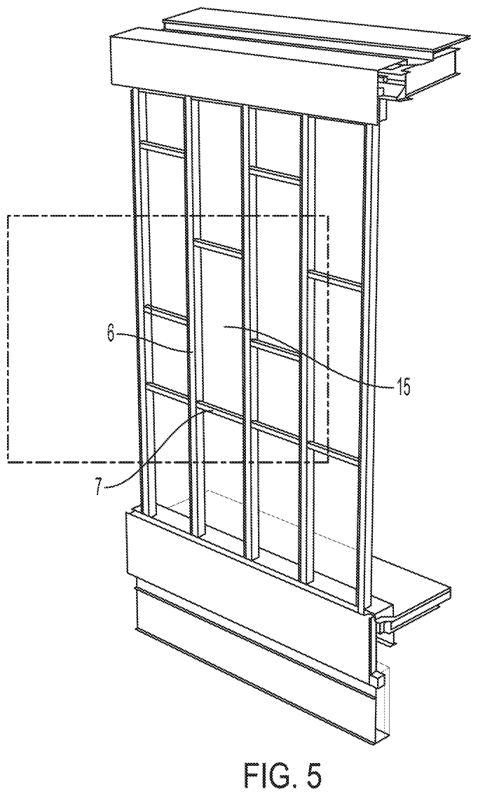

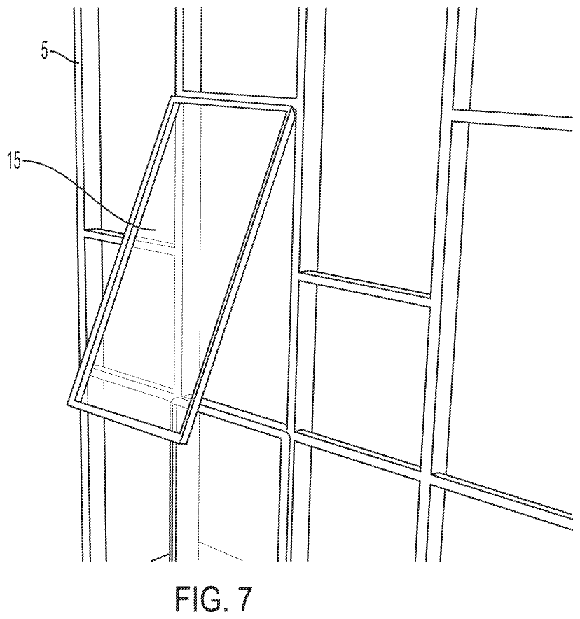

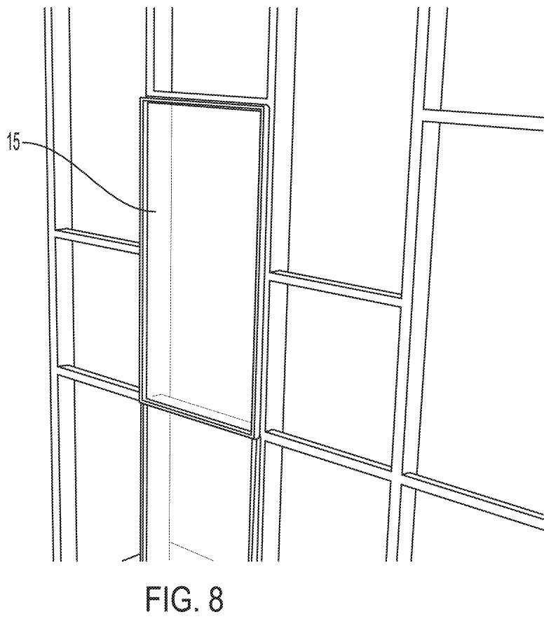

With reference now to the drawings, and in particular to FIGS. 1 through 13 thereof, a new cassette framing system embodying the principles and concepts of the present invention will now be described.

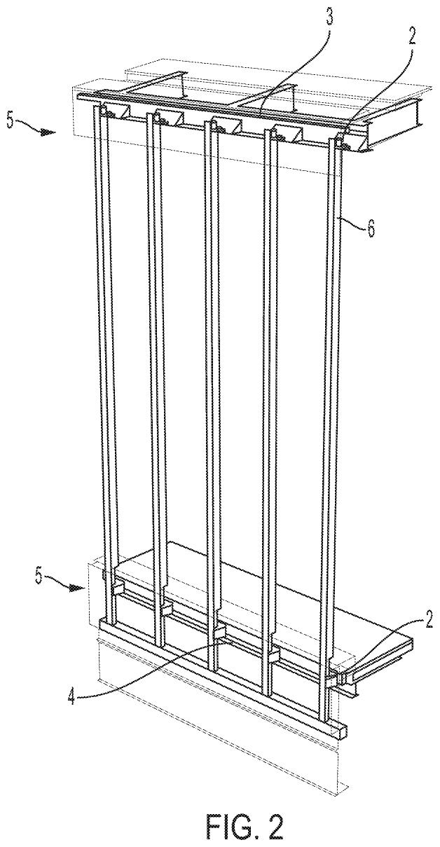

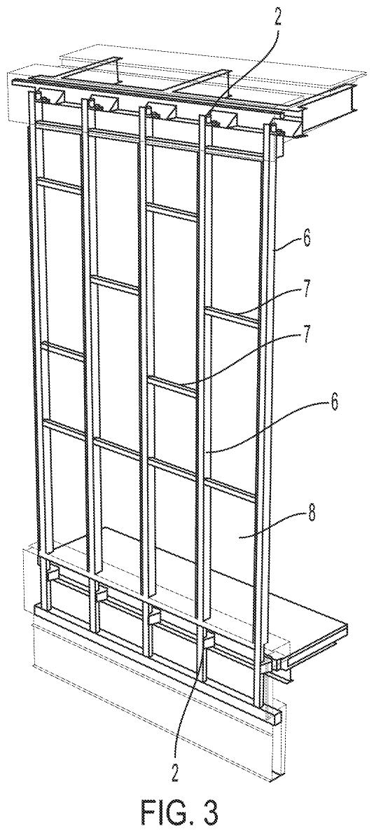

The present invention is adapted for use within an opening wherein structural mullions may be anchored into an opening of a cassette framing system. FIG. 1 shows a potential configuration for the placement of the structural mullions [1] against anchor points [2] located on an upper periphery edge [3] and on a lower periphery edge [4] of a cassette framing system [5]. The vertical mullions [6] are attached to anchor points [2] located on an upper periphery edge [3] and on a lower periphery edge [4] within a cassette framing system [5]. Note FIG. 2. Horizontal mullions [7] are attached to the vertical mullions [6] within the cassette framing system. Note FIG. 3.

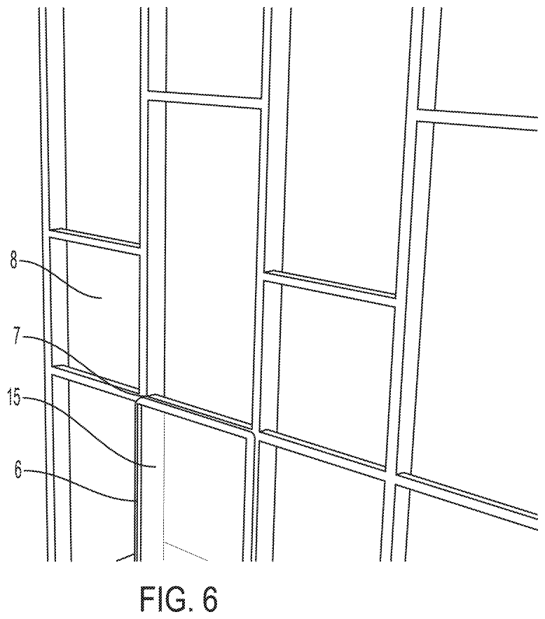

One or more cassettes [15] may then be mounted onto the horizontal and vertical mullions [6, 7], into the open space or spaces [8] created by the placement of the mullions onto the cassette framing system. Note FIGS. 3, 4, 5. A close-up rendering of the mullions anchored onto the cassette framing system depicts the open spaces [8] created by the placement of such mullions. Note FIG. 6. A cassette is mounted onto the structural mullions such that the open space, created by the placement of the structural mullions, is filled when the cassette is in its mounted and resting position. FIGS. 6, 7, 8.

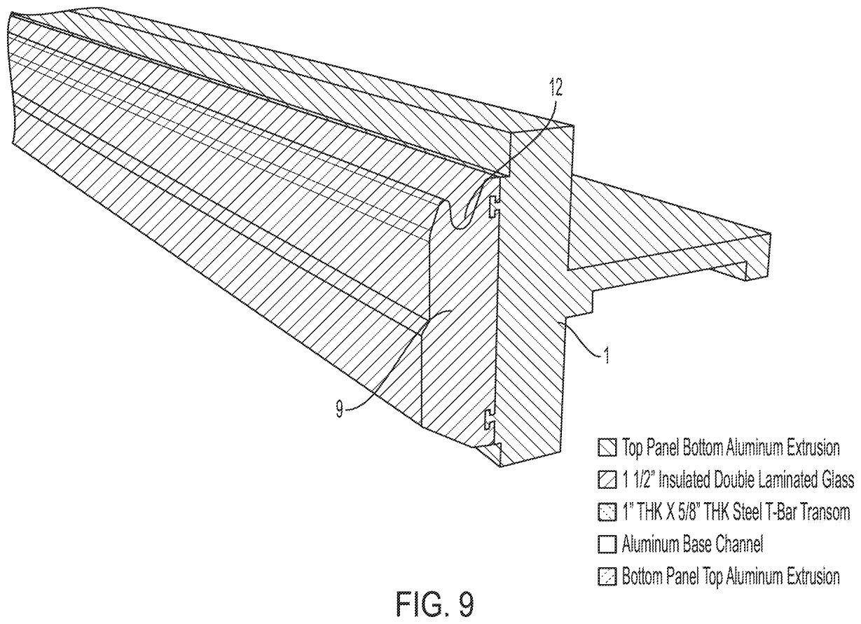

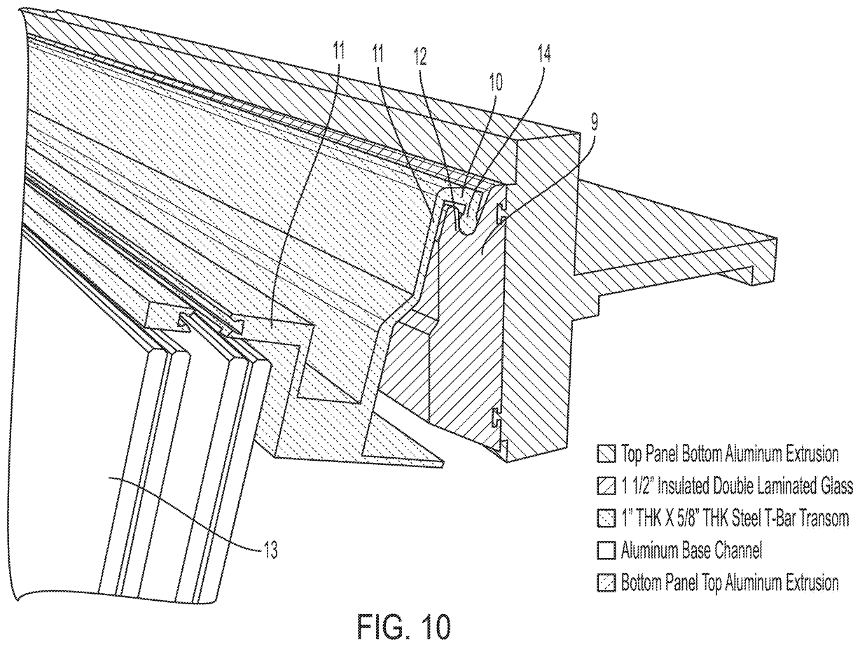

Hinge assembly units are used to mount the cassettes within the open space. A hinge assembly unit is comprised of a cassette receiver [9] located on a structural mullion [1], and the upper rim [10] of a cassette frame [11]. See FIGS. 9, 10. The upper rim [10] of the cassette frame [11] connects with a cassette receiver [9] which contains a groove [12] for receiving the hinge frame. FIG. 9 shows a partial cross section view of a cassette receiver attached to a horizontal structural mullion. FIG. 10 shows a partial cross section view of the upper rim [10] of the cassette frame with a mounting arm [14] located on the cassette frame, which fits into the groove [12] in the cassette receiver [9]. Infill material [13], such as glass, is attached to the cassette frame [11]. Options for infill materials include, but are not limited to plastic, metal, stone, concrete, and cement. A variety of types of infill materials may be used.

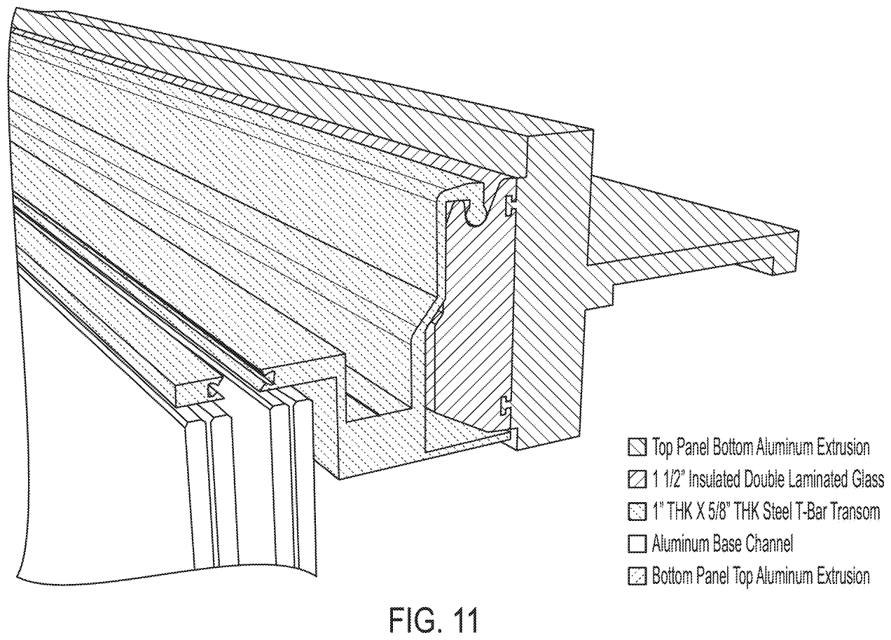

The upper rim [10] of the cassette frame [11] is mounted onto the structural mullion [1] by positioning and resting the mounting arm [14] of the cassette frame [11] within the groove [12] of the cassette receiver [9]. FIGS. 10, 11. The cassette frame is then affixed to the structural mullion and to the cassette framing system.

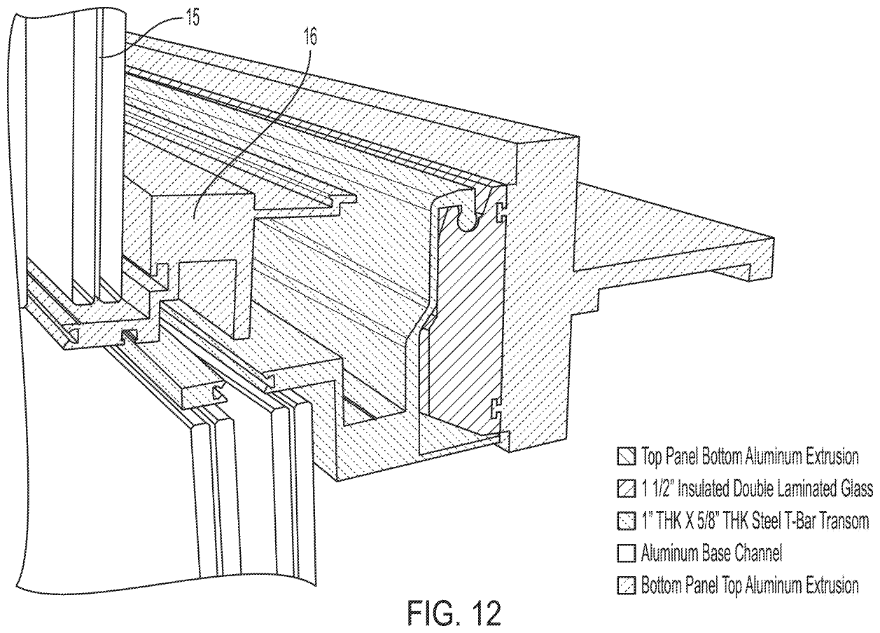

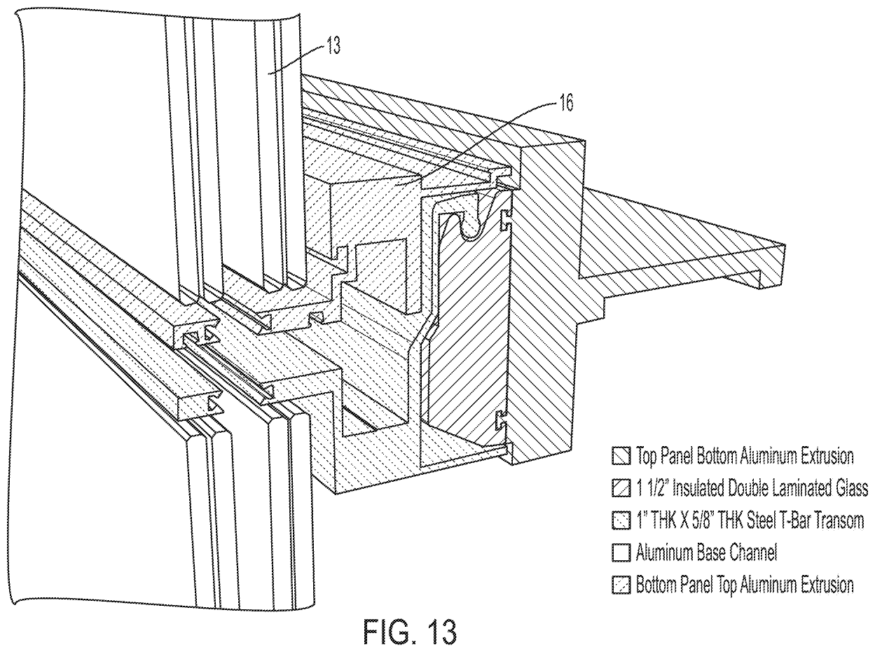

The cassette frame may be affixed to the structural mullion and to one or more neighboring mullions with screws or other mechanical fasteners. The use of a chemical adhesive is another option for affixing the cassette frame to one or more structural mullions. Heat may also be used to solder, weld, braze, or otherwise fasten the cassette to one or more structural mullions. Another option is to have the cassette frame extend down the sides of the cassette. Yet another option is to have the cassette frame extend to the bottom edge [16] of the cassette. FIG. 12 Thus, the cassette may be affixed with screws, mechanical fasteners, soldered, welded, brazed or otherwise affixed along the sides or along the bottom edge of the cassette frame. Mechanical fasteners, heat, and chemical adhesives may similarly be used to affix the horizontal mullions to the vertical mullions. FIGS. 11, 12 shows a partial cross section view of a second cassette [15] being mounted onto the cassette framing system, and into the open space created by neighboring structural mullions. As set in this paragraph, one embodiment of the invention is to add a bottom edge to the second cassette's frame and to mount the bottom edge to the frame of the cassette located directly below the subject cassette. The bottom edge may be affixed to the top edge of a second cassette's frame for additional support and stability. FIG. 13. Alternatively, the bottom edge may be affixed directly to a horizontal mullion. Other embodiments may eliminate the bottom edge of a cassette.

While the included drawings depict a cassette frame with an upper rim and a mounting arm which spans the top edge of the cassette, one skilled in the art would appreciate that the mounting arm may be reduced in width. The width of the mounting arm may be reduced considerably such that the mounting arm resembles a clasp, which catches onto the groove located on the cassette receiver, during the mounting process. One skilled in the art would also appreciate that additional materials such as gaskets, thermal breaks, structural silicone, and glazing tape may be used to increase the structural integrity of the cassette framing system, to prevent the conduction of energy through the cassettes, to improve the sealing of edges surrounding the edges of the cassette frame, infill material and mullions, and to prevent leakages of air, water, and other substances.

In other embodiments of the invention, the placement of the structural mullions within the opening may vary and result in different configurations of the mullions. In another embodiment of the invention, the cassette framing system may consist of a single cassette, or it may consist of more than one cassette.

The present invention is not limited to the embodiments described herein. One embodiment would be the installation of glass window cassettes within a cassette framing system. But the present invention is not limited to this embodiment. As noted herein, other infill materials such as steel may be used, for various other applications. Those skilled in the art will appreciate that the invention, upon which this disclosure is based may readily be used as a basis for designing other structures, methods, and system for carrying out the purposes of the present invention.

With respect to the description herein, optimal dimensional relationships for the parts of the invention, including variations in size, materials, shape, form, function, manner of operation, assembly and use are deemed readily apparent and obvious to one skilled in the art. All equivalent relationships to those illustrated in the drawings and described in the specification are intended to be encompassed by the present invention.

The foregoing is considered as illustrative only as to the principles of the invention. Numerous modifications and changes will readily occur to those skilled in the art and the foregoing is not intended to limit the invention to the exact construction and operation shown and described. Accordingly, all suitable modifications and equivalents are resorted to fall within the scope of the invention.

We claim:

1. A cassette framing system comprising:
a.) a cassette;
b) a cassette frame framing one or more edges of the cassette;
c) a structural mullion having a cassette receiver, which includes a groove; and
d) a rim located on an edge of the cassette frame, having a mounting arm, which is coupled to the groove such that the groove receives the mounting arm of the rim and permits the cassette to be mounted onto the structural mullion.

2. The cassette framing system according to claim 1, wherein the structural mullion is horizontally placed, and the mounting arm on the rim is located on the top edge of the cassette.

3. The cassette framing system according to claim 1, wherein the structural mullion is vertically placed, and the mounting arm of the rim is located on the lateral edge of the cassette.

4. The cassette framing system according to claim 1, wherein two or more edges of the cassette frame have rims with mounting arms which couple to two more structural mullions containing cassette receivers having grooves.

5. The cassette framing system according to claim 1, wherein the rim located on the edge of the cassette frame has two or more mounting arms, and the cassette receiver on the structural mullion contains two or more grooves which couple with the mounting arms.

6. The cassette framing system according to claim 1, wherein the rim located on the edge of the cassette frame has two or more mounting arms, which arms have widths which span only a partial portion of the edge of the cassette frame, and which couple to cassette receivers with grooves which have widths which span only a partial portion of the structural mullion.

7. The cassette framing system according to claim 1, wherein the cassette is affixed along its edges to one or more structural mullions.

8. A cassette framing system comprising:
a) a horizontal structural mullion;
b) a cassette;
c) a cassette frame framing one or more edges of the cassette; and
d) a hinge assembly coupling the cassette to the structural mullion such that the cassette is mounted onto the structural mullion, the hinge assembly including a rim containing a mounting arm, located on an edge of the cassette frame, and a cassette receiver containing a groove, located on the horizontal structural mullion, which groove receives the mounting arm of the rim.

9. The cassette framing system according to claim 8, wherein two edges of the cassette frame have rims with mounting arms, which couple to two horizontal structural mullions containing cassette receivers having grooves.

10. The cassette framing system according to claim 8, wherein the rim located on the edge of the cassette frame has two or more mounting arms, and the cassette receiver on the structural mullion contains two or more grooves which couple with the mounting arms.

11. The cassette framing system according to claim 8, wherein the rim located on the edge of the cassette frame has two or more mounting arms, which arms have widths which span only a partial portion of the edge of the cassette frame, and which couple to cassette receivers with grooves which have widths which span only a partial portion of the structural mullion.

12. The cassette framing system according to claim 8, wherein the cassette is affixed along its edges to one or more structural mullions.

13. A method of framing and attaching cassettes to a cassette framing system comprising the steps of adding a structural mullion with a cassette receiver having a groove to a cassette framing system, coupling a mounting arm located on a rim of a cassette frame, containing a cassette, to the groove located on the cassette receiver on a structural mullion, and mounting the cassette to the cassette framing system.

14. The method of framing and attaching cassettes to a cassette framing system according to claim 13, wherein the structural mullion is horizontally placed, and the rim with the mounting arm is located on the top edge of the cassette.

15. The method of framing and attaching cassettes to a cassette framing system according to claim 13, wherein the structural mullion is vertically placed, and the rim with the mounting arm is located on the lateral edge of the cassette.

16. The method of framing and attaching cassettes to a cassette framing system according to claim 13, wherein two or more edges of the cassette frame have mounting arms with rims, which couple to two more structural mullions with cassette receivers having grooves.

17. The method of framing and attaching cassettes to a cassette framing system according to claim 13, wherein the rim located on the edge of the cassette frame has two or more mounting arms, and the cassette receiver on the structural mullion contains two or more grooves which couple with the mounting arms.

18. The method of framing and attaching cassettes to a cassette framing system according to claim 13, wherein the rim located on the edge of the cassette frame has two or more mounting arms, which arms have widths which span only a partial portion of the edge of the cassette frame, and which couple to cassette receivers with grooves which have widths which span only a partial portion of the structural mullion.

19. The method of framing and attaching cassettes to a cassette framing system according to claim 13, wherein the cassette is affixed along its edges to one or more structural mullions.
